(19) United States
(12) Patent Application Publication
(10) Pub. No.: US 2024/0047793 A1
(43) Pub. Date: Feb. 8, 2024

(54) SOLID-STATE BATTERY PACKAGE

(71) Applicant: Murata Manufacturing Co., Ltd., Nagaokakyo-shi (JP)

(72) Inventors: Haruhiko IKEDA, Nagaokakyo-shi (JP); Toshitaka HAYASHI, Nagaokakyo-shi (JP); Kouji ISHIKAWA, Nagaokakyo-shi (JP); Tomohiro KATO, Nagaokakyo-shi (JP); Toshiya KAWATE, Nagaokakyo-shi (JP); Norikazu KUME, Nagaokakyo-shi (JP); Akihiro MORI, Nagaokakyo-shi (JP)

(21) Appl. No.: 18/487,403

(22) Filed: Oct. 16, 2023

Related U.S. Application Data
(63) Continuation of application No. PCT/JP2022/018942, filed on Apr. 26, 2022.

(30) Foreign Application Priority Data
Apr. 26, 2021 (JP) 2021-074349

(51) Int. Cl. H01M 50/126; H01M 50/11; H01M 50/119; H01M 50/121

(52) U.S. Cl. CPC H01M 50/126; H01M 50/11; H01M 50/119; H01M 50/121

(57) ABSTRACT

A solid-state battery package that includes: a substrate; a solid-state battery on the substrate; and a water vapor barrier layer between the substrate and the solid-state battery. The water vapor barrier layer preferably has both an Si—O bond and an Si—N bond, and preferably has a water vapor transmission rate of less than 5×10⁻³ g/(m²·Day).

### CROSS REFERENCE TO RELATED APPLICATIONS

The present application is a continuation of International application No. PCT/JP2022/018942, filed Apr. 26, 2022, which claims priority to Japanese Patent Application No. 2021-074349, filed Apr. 26, 2021, the entire contents of each of which are incorporated herein by reference.

### TECHNICAL FIELD

The present invention relates to a solid-state battery package. More specifically, the present invention relates to a solid-state battery packaged so as to be adapted for mounting.

### BACKGROUND ART

Hitherto, secondary batteries that can be repeatedly charged and discharged have been used for various purposes. For example, secondary batteries are used as power sources of electronic devices such as smartphones and notebooks.

In secondary batteries, a liquid electrolyte is generally used as a medium for ion transfer contributing to charging and discharging. That is, a so-called electrolytic solution is used for the secondary battery. However, in such a secondary battery, safety is generally required from the viewpoint of preventing leakage of an electrolytic solution. Since an organic solvent or the like used for the electrolytic solution is a flammable substance, safety is required also in that respect.

Therefore, solid-state batteries using a solid electrolyte instead of an electrolytic solution have been studied.
Patent Document 1: Japanese Patent Application Laid-Open No. 2015-220107
Patent Document 2: Japanese Patent Application Laid-Open No. 2007-5279

### SUMMARY OF THE INVENTION

The inventor of the present application has noticed that there is still a problem to be overcome in the previously proposed solid-state battery, and has found a need to take measures therefor. Specifically, the inventor of the present application has found that there are the following problems.

It is conceivable that a solid-state battery is used by being mounted on a printed wiring board and the like together with other electronic components, and in that case, a structure suitable for mounting is required. For example, a package in which a solid-state battery is disposed on a substrate has the substrate electrically connect with the outside and thereby is adapted for mounting.

However, the inventor of the present application has noticed it is not always true that the package in which a solid-state battery is disposed on a substrate is capable of sufficiently preventing the infiltration of water vapor from the substrate side. That is, the present inventor has found that the substrate itself is a thick member and can prevent water vapor infiltration to some extent, which may be, however, insufficient for the solid-state battery, and there remains a concern that the solid-state battery characteristics may deteriorate in a longer term.

The present invention has been devised in view of such problems. That is, a main object of the present invention is to provide a technique of a solid-state battery that has a substrate adapted for mounting and is capable of more effectively preventing water vapor transmission associated with the substrate.

The inventor of the present application has attempted to solve the above-described problems by addressing the problems in a new direction rather than addressing the problems as an extension of the prior art. As a result, a solid-state battery that achieves the above main object has been invented.

The present invention provides a solid-state battery package including: a substrate; a solid-state battery on the substrate; and a water vapor barrier layer between the substrate and the solid-state battery.

The solid-state battery package according to the present invention has a substrate adapted for mounting and has more excellent performance of preventing water vapor transmission.

More specifically, the present invention is a solid-state battery package for which prevention of water vapor transmission through a substrate adapted for mounting is more suitably considered. The solid-state battery package according to the present invention, provided with a water vapor barrier layer between the substrate and the solid-state battery, reduces undesirable permeation of water vapor in the external environment to the solid-state battery via the substrate. Therefore, the solid-state battery package of the present invention is less likely to cause deterioration of the solid-state battery characteristics in a longer period of time, and has higher reliability.

### BRIEF EXPLANATION OF THE DRAWINGS

FIG. 1 is a sectional view schematically illustrating a solid-state battery package.

FIG. 2 is a sectional view schematically illustrating a solid-state battery package.

FIG. 3 is a sectional view schematically illustrating a solid-state battery package, and is a view for particularly explaining a “layer constituting a substrate” and a “layer constituting a solid-state battery”.

FIG. 4 is a sectional view schematically illustrating a solid-state battery package and a partly enlarged view thereof, and is a view for explaining, in particular, a broad range of extension form of a water vapor barrier layer.

FIG. 5 is a sectional view schematically illustrating a solid-state battery package and a partly enlarged view thereof, and is a view particularly for a description related to a resist layer.

FIG. 6 is a sectional view schematically illustrating a solid-state battery package and a schematic view illustrating a substrate configuration.

FIG. 7 is a schematic view illustrating each layer constituting a substrate.

FIG. 8 is a sectional view schematically illustrating a solid-state battery package and a plan view illustrating a metal layer included in a substrate.

FIGS. 9(A) to 9(E) are process sectional views schematically illustrating a process of obtaining a solid-state battery package.

FIG. 10 is a sectional view schematically illustrating a solid-state battery package, and is a view particularly for explaining an aspect related to non-installation of a resist.

FIG. 11 is a sectional view schematically illustrating a solid-state battery package, and is a view particularly for explaining an aspect of a covering inorganic layer.

FIG. 12 is a sectional view schematically illustrating a solid-state battery package, and is a schematic view particularly illustrating a certain substrate configuration example.

FIG. 13 is a sectional view schematically illustrating a solid-state battery package and a partly enlarged view thereof, and is a view particularly for a description related to a conductive paste.

### DETAILED DESCRIPTION OF THE INVENTION

Hereinafter, a solid-state battery package according to the present invention will be described in detail. Although the description will be made with reference to the drawings as necessary, the illustrated contents are only schematically and exemplarily illustrated for the understanding of the present invention, and the appearance and/or the dimensional ratio and the like may be different from the actual ones.

The term “solid-state battery package” as used herein refers, in a broad sense, to a solid-state battery device (or a solid-state battery article) configured to protect the solid-state battery from the external environment, and in a narrow sense, to a solid-state battery article that includes a substrate adapted for mounting and protects the solid-state battery from the external environment.

The term “sectional view” as used herein is based on a form viewed from a direction substantially perpendicular to the stacking direction in the stacked structure of the solid-state battery (briefly, a form in the case of being cut along a plane parallel to the layer thickness direction). In addition, the term “plan view” or “plan view shape” used in the present specification is based on a sketch drawing when an object is viewed from an upper side or a lower side along the layer thickness direction (that is, the above stacking direction). Briefly, the shape of a target surface viewed from the normal direction can be regarded as the “plan view shape”.

The terms “up-down direction” and “left-right direction” directly or indirectly used in the present specification respectively correspond to the up-down direction and the left-right direction in the drawings. Unless otherwise specified, the same reference signs or symbols denote the same members and/or sites, or the same semantic contents. In a preferred aspect, it can be understood that a downward direction in a vertical direction (that is, a direction in which gravity acts) corresponds to a “downward direction”/“bottom surface side”, and an opposite direction thereof corresponds to an “upward direction”/“top surface side”.

The term “solid-state battery” used in the present invention refers to, in a broad sense, a battery whose constituent elements are composed of solid and refers to, in a narrow sense, all solid-state battery whose constituent elements (particularly preferably all constituent elements) are composed of solid. In a preferred aspect, the solid-state battery in the present invention is a stacked solid-state battery configured such that layers constituting a battery constituent unit are stacked on each other, and such layers are preferably composed of fired bodies. The term “solid-state battery” encompasses not only a so-called “secondary battery” that can be repeatedly charged and discharged but also a “primary battery” that can only be discharged. According to a preferred aspect of the present invention, the “solid-state battery” is a secondary battery. The term “secondary battery” is not to be considered excessively restricted by its name, which can encompass, for example, a power storage device and the like. In the present invention, the solid-state battery included in the package can also be referred to as a “solid-state battery element”.

Hereinafter, the basic configuration of the solid-state battery of the present invention will be first described. The configuration of the solid-state battery described here is merely an example for understanding the invention, and does not limit the invention.

[Basic Configuration of Solid-State Battery]

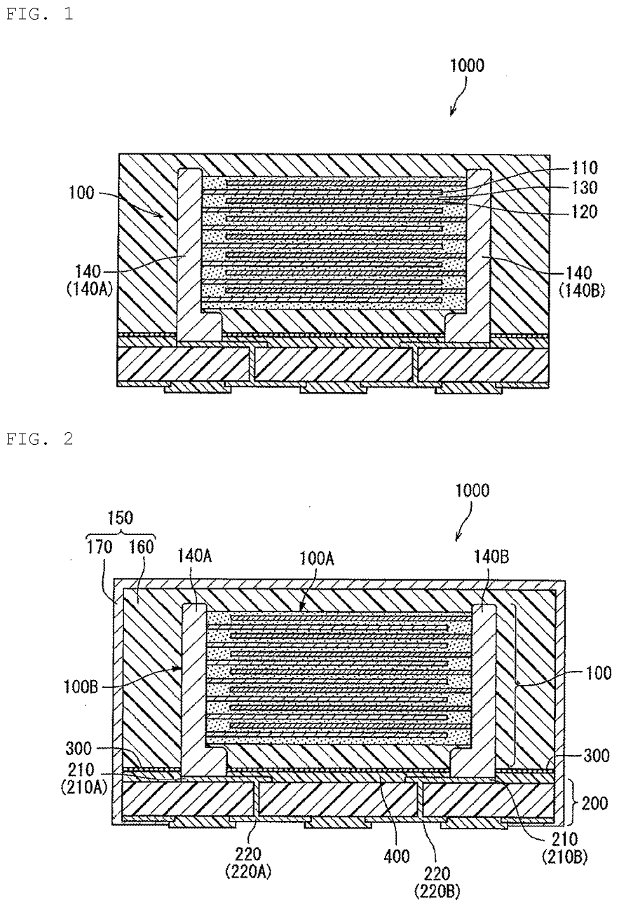

The solid-state battery includes at least electrode layers of a positive electrode and a negative electrode and a solid electrolyte. Specifically, as illustrated in FIG. 1, a solid-state battery 100 includes a solid-state battery stacked body having a battery constituting unit consisting of a positive electrode layer 110, a negative electrode layer 120, and a solid electrolyte 130 at least interposed between these electrode layers.

For the solid-state battery, each layer constituting the solid-state battery may be formed by firing, and the positive electrode layer, the negative electrode layer, the solid electrolyte, and the like may form fired layers. Preferably, the positive electrode layer, the negative electrode layer, and the solid electrolyte are each fired integrally with each other, and thus, the solid-state battery stacked body preferably forms an integrally fired body.

The positive electrode layer 110 is an electrode layer containing at least a positive electrode active material. The positive electrode layer may further contain a solid electrolyte. In a preferred aspect, the positive electrode layer is composed of a fired body including at least positive electrode active material particles and solid electrolyte particles. In contrast, the negative electrode layer is an electrode layer containing at least a negative electrode active material. The negative electrode layer may further contain a solid electrolyte. In a preferred aspect, the negative electrode layer is composed of a sintered body containing at least negative electrode active material particles and solid electrolyte particles.

The positive electrode active material and the negative electrode active material are substances involved in accepting and donating electrons in the solid-state battery. Ions move (or conduct) between the positive electrode layer and the negative electrode layer through the solid electrolyte to accept and donate electrons, whereby charging and discharging are performed. Each electrode layer of the positive electrode layer and the negative electrode layer is preferably a layer capable of occluding and releasing lithium ions or sodium ions, in particular. More particularly, the solid-state battery is preferably an all-solid-state secondary battery in which lithium ions or sodium ions move between the positive electrode layer and the negative electrode layer through the solid electrolyte interposed, thereby charging and discharging the battery.

(Positive Electrode Active Material)

Examples of the positive electrode active material included in the positive electrode layer 110 include at least one selected from the group consisting of lithium-containing phosphate compounds that have a NASICON-type structure, lithium-containing phosphate compounds that have an olivine-type structure, lithium-containing layered oxides, lithium-containing oxides that have a spinel-type structure, and the like. Examples of the lithium-containing phosphate compounds that have a NASICON-type structure include Li₃V₂(PO₄)₃. Examples of the lithium-containing phosphate compounds that have an olivine-type structure include Li₃Fe₂(PO₄)₃, LiFePO₄, and/or LiMnPO₄. Examples of the lithium-containing layered oxides include LiCoO₂ and/or LiCo_{1/3}Ni_{1/3}O₂. Examples of the lithium-containing oxides that have a spinel-type structure include LiMn₂O₄ and/or LiNi_{0.5}Mn_{1.5}O₄. The types of the lithium compounds are not particularly limited, and may be regarded as, for example, a lithium-transition metal composite oxide and a lithium-transition metal phosphate compound. The lithium-transition metal composite oxide is a generic term for oxides containing lithium and one or two or more transition metal elements as constituent elements, and the lithium transition metal phosphate compound is a generic term for phosphate compounds containing lithium and one or two or more transition metal elements as constituent elements. The types of transition metal elements are not particularly limited and are, for example, cobalt (Co), nickel (Ni), manganese (Mn), iron (Fe), and the like.

In addition, examples of positive electrode active materials capable of occluding and releasing sodium ions include at least one selected from the group consisting of sodium-containing phosphate compounds that have a NASICON-type structure, sodium-containing phosphate compounds that have an olivine-type structure, sodium-containing layered oxides, sodium-containing oxides that have a spinel-type structure, and the like. For example, in the case of the sodium-containing phosphate compounds, examples thereof include at least one selected from the group consisting of Na₃V₂(PO₄)₃, NaCoFe₂(PO₄)₃, Na₂Ni₂Fe(PO₄)₃, Na₃Fe₂(PO₄)₃, Na₂FeP₂O₇, Na₄Fe₃(PO₄)₂(P₂O₇), and NaFeO₂ as a sodium-containing layered oxide.

In addition, the positive electrode active material may be, for example, an oxide, a disulfide, a chalcogenide, a conductive polymer, or the like. The oxide may be, for example, a titanium oxide, a vanadium oxide, a manganese dioxide, or the like. The disulfide is, for example, a titanium disulfide, a molybdenum sulfide, or the like. The chalcogenide may be, for example, a niobium selenide or the like. The conductive polymer may be, for example, a disulfide, a polypyrrole, a polyaniline, a polythiophene, a poly-para-styrene, a polyacetylene, a polyacene, or the like.

(Negative Electrode Active Material)

Examples of the negative electrode active material included in the negative electrode layer 120 include at least one selected from the group consisting of oxides containing at least one element selected from the group consisting of titanium (Ti), silicon (Si), tin (Sn), chromium (Cr), iron (Fe), niobium (Nb), and molybdenum (Mo), carbon materials such as graphite, graphite-lithium compounds, lithium alloys, lithium-containing phosphate compounds that have a NASICON-type structure, lithium-containing phosphate compounds that have an olivine-type structure, and lithium-containing oxides that have a spinel-type structure. Examples of the lithium alloys include Li—Al. Examples of the lithium-containing phosphate compounds that have a NASICON-type structure include Li₃V₂(PO₄)₃ and/or LiTi₂(PO₄)₃. Examples of the lithium-containing phosphate compounds that have an olivine-type structure include Li₃Fe₂(PO₄)₃ and/or LiCuPO₄. Examples of the lithium-containing oxides that have a spinel-type structure include Li₄Ti₅O₁₂.

In addition, examples of negative electrode active materials capable of occluding and releasing sodium ions include at least one selected from the group consisting of sodium-containing phosphate compounds that have a NASICON-type structure, sodium-containing phosphate compounds that have an olivine-type structure, and sodium-containing oxides that have a spinel-type structure.

Further, in the solid-state battery, the positive electrode layer and the negative electrode layer may be made of the same material.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

Further, the positive electrode layer and/or the negative electrode layer may include a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thicknesses of the positive electrode layer and negative electrode layer are not particularly limited, but may be, independently of each other, for example, 2 μm to 50 μm, particularly 5 μm to 30 μm.

(Positive Electrode Current Collecting Layer/Negative Electrode Current Collecting Layer)

Although not an essential element for the electrode layer, the positive electrode layer 110 and the negative electrode layer 120 may respectively include a positive electrode current collecting layer and a negative electrode current collecting layer. The positive electrode current collecting layer and the negative electrode current collecting layer may each have the form of a foil. The positive electrode current collecting layer and the negative electrode current collecting layer may each have, however, the form of a fired body, if more importance is placed on viewpoints such as improving the electron conductivity, reducing the manufacturing cost of the solid-state battery, and/or reducing the internal resistance of the solid-state battery by integral firing. As the positive electrode current collector constituting the positive electrode current collecting layer and the negative electrode current collector constituting the negative electrode current collecting layer, it is preferable to use a material with a high conductivity, and for example, silver, palladium, gold, platinum, aluminum, copper, and/or nickel may be used. The positive electrode current collector and the negative electrode current collector may each have an electrical connection for being electrically connected to the outside, and may be configured to be electrically connectable to an end-face electrode. It is to be noted that when the positive electrode current collecting layer and the negative electrode current collecting layer have the form of a fired body, the layers may be composed of a fired body including a conductive material and a sintering aid. The conductive material included in the positive electrode current collecting layer and the negative electrode current collecting layer may be selected from, for example, the same materials as the conductive materials that can be included in the positive electrode layer and the negative electrode layer. The sintering aid included in the positive electrode current collecting layer and the negative electrode current collecting layer may be selected from, for example, the same materials as the sintering aids that can be included in the positive electrode layer/the negative electrode layer. As described above, in the solid-state battery, the positive electrode current collecting layer and the negative electrode current collecting layer are not essential, and a solid-state battery provided without such a positive electrode current collecting layer or a negative electrode current collecting layer is also conceivable. More particularly, the solid-state battery included in the package of the present invention may be a solid-state battery without any current collecting layer.

(Solid Electrolyte)

The solid electrolyte is a material capable of conducting lithium ions or sodium ions. In particular, the solid electrolyte 130 that forms the battery constituent unit in the solid-state battery may form a layer capable of conducting lithium ions between the positive electrode layer 110 and the negative electrode layer 120. It is to be noted that the solid electrolyte has only to be provided at least between the positive electrode layer and the negative electrode layer. More particularly, the solid electrolyte may be present around the positive electrode layer and/or the negative electrode layer so as to protrude from between the positive electrode layer and the negative electrode layer. Specific examples of the solid electrolyte include any one, or two or more of a crystalline solid electrolyte, a glass-based solid electrolyte, and a glass ceramic-based solid electrolyte.

Examples of the crystalline solid electrolyte include oxide-based crystal materials and sulfide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors. Examples of the lithium-containing phosphate compound that has a NASICON structure include LiₓM_{y}(PO₄)₃ (1≤x≤2, 1≤y≤2, M is at least one selected from the group consisting of titanium (Ti), germanium (Ge), aluminum (Al), gallium (Ga), and zirconium (Zr)). Examples of the lithium-containing phosphate compounds that have a NASICON structure include Li_{1.2}Al_{0.2}Ti_{1.8}(PO₄)₃. Examples of the oxides that have a perovskite structure include La_{0.55}Li_{0.35}TiO₃. Examples of the oxides that have a garnet-type or garnet-type similar structure include Li₇La₃Zr₂O₁₂. In addition, examples of the sulfide-based crystal materials include thio-LISICON, for example, Li_{3.25}Ge_{0.25}P_{0.75}S₄ and Li₁₀GeP₂S₁₂. The crystalline solid electrolyte may contain a polymer material (for example, a polyethylene oxide (PEO)).

Examples of the glass-based solid electrolyte include oxide-based glass materials and sulfide-based glass materials. Examples of the oxide-based glass materials include 50Li₄SiO₄-50Li₃BO₃. In addition, examples of the sulfide-based glass materials include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

Examples of the glass ceramic-based solid electrolyte include oxide-based glass ceramic materials and sulfide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. LAGP is, for example, Li_{1.5}Al_{0.5}Ge_{1.5}(PO₄). In addition, examples of the sulfide-based glass ceramic materials include Li₇P₃S₁₁ and Li_{3.25}P_{0.95}S₄.

In addition, examples of the solid electrolyte capable of conducting sodium ions include sodium-containing phosphate compounds that have a NASICON structure, oxides that have a perovskite structure, and oxides that have a garnet-type or garnet-type similar structure. Examples of the sodium-containing phosphate compounds that have a NASICON structure include NaₓM_{y}(PO₄)₃ (1≤x≤2, 1≤y≤2, and M is at least one selected from the group consisting of Ti, Ge, Al, Ga, and Zr).

The solid electrolyte may include a sintering aid. The sintering aid contained in the solid electrolyte may be selected from, for example, the same materials as the sintering aid that can be contained in the positive electrode layer and the negative electrode layer.

The thickness of the solid electrolyte is not particularly limited. The thickness of the solid electrolyte layer located between the positive electrode layer and the negative electrode layer may be, for example, 1 μm to 15 μm, particularly 1 μm to 5 μm.

(End-Face Electrode)

The solid-state battery is typically provided with end-face electrodes 140. In particular, an end-face electrode is provided on a side surface of the solid-state battery. More specifically, the side surfaces are provided with a positive-electrode-side end-face electrode 140A connected to the positive electrode layer 110 and a negative-electrode-side end-face electrode 140B connected to the negative electrode layer 120 (see FIG. 1). Such end-face electrodes preferably contain a material having high conductivity. The specific materials of the end-face electrodes are to be considered not particularly limited, but examples thereof include at least one selected from the group consisting of silver, gold, platinum, aluminum, copper, tin, and nickel.

[Feature of Solid-State Battery Package According to Present Invention]

According to the present invention, the solid-state battery is packaged. More particularly, the solid-state battery package includes a substrate adapted for mounting, and has a configuration in which the solid-state battery is protected from the external environment.

The solid-state battery package of the present invention is characterized in that water vapor transmission associated with the substrate can be more effectively prevented. That is, the package is not only simply packaged, but also designed to prevent water vapor transmission from the viewpoint of the substrate adapted for mounting.

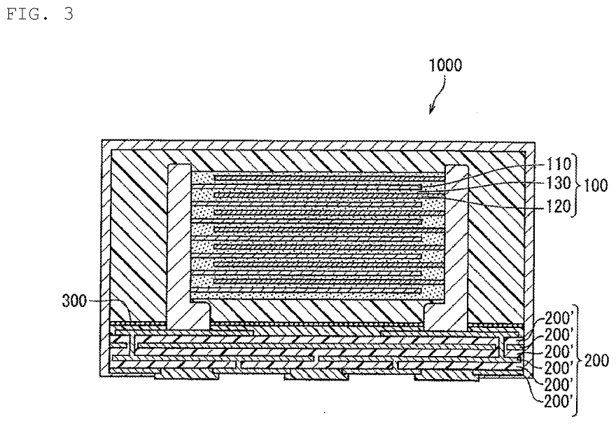

Specifically, the solid-state battery package of the present invention includes a substrate and a solid-state battery provided thereon, and includes a water vapor barrier layer therebetween. That is, as shown in FIG. 2, a solid-state battery package 1000 includes a substrate 200 so that a solid-state battery 100 is supported, and a water vapor barrier layer 300 is provided between the solid-state battery 100 and the substrate 200. Such a solid-state battery package reduces undesirable permeation of water vapor in the external environment to the solid-state battery via the substrate, thereby reducing or preventing deterioration of the solid-state battery characteristics in a longer period of time.

The substrate 200 is disposed proximal to one main surface side of the solid-state battery 100, and is disposed so as to block the main surface of the solid-state battery 100 from the external environment. Therefore, although it is usually considered that water vapor infiltration into the solid-state battery can be prevented by the presence of the substrate, the present inventor particularly pays attention to the fact that only the substrate is insufficient to prevent water vapor transmission. This is because the substrate can exhibit permeability to water vapor in the external environment due to the material and/or configuration of the substrate in the long term. For this reason, the present invention provides the water vapor barrier layer 300 between the solid-state battery 100 and the substrate 200 to effectively suppress the water vapor transmission to the solid-state battery 100 through the substrate 200. Therefore, it is achieved to suppress or prevent, for example, a disadvantageous phenomenon that water vapor (or moisture) infiltrating from the substrate and the solid electrolyte are reacted to cause a decrease in the ionic conductivity of the solid electrolyte.

The term “water vapor” as used in the present specification is not particularly limited to water in a gaseous state, and includes water in a liquid state and the like. That is, the term “water vapor” is used to broadly include matters related to water regardless of the physical state. Therefore, the term “water vapor” can also be referred to as moisture or the like, and in particular, as the water in the liquid state, dew condensation water in which water in a gaseous state is condensed can also be included.

The present invention is a packaged solid-state battery, and may have a configuration contributing to water vapor transmission prevention not only on the substrate but also as a whole. For example, the solid-state battery package of the present invention may be covered with a covering material so that the solid-state battery provided on the substrate is surrounded as a whole. Specifically, it may be packaged so that the side surface and main surface of the solid-state battery on the substrate is surrounded with a covering material. In such a configuration, all surfaces forming the solid-state battery are not exposed to the outside, and the water vapor transmission can be more suitably prevented.

For example, the covering material may be composed of a covering insulating layer and a covering inorganic film. That is, as shown in FIG. 2, the solid-state battery 100 provided on the substrate 200 may be covered with a covering insulating layer 160 and a covering inorganic layer 170 thereon as a covering material 150. The covering insulating layer 160 is a layer provided so as to cover the main surface and the side surface of the solid-state battery 100. As shown in FIG. 2, the covering insulating layer 160 is provided so as to cover at least a top surface 100A and a side surface 100B of the solid-state battery 100, and the solid-state battery 100 on the substrate 200 is largely wrapped by the covering insulating layer 160 as a whole. The material of the covering insulating layer 160 may be any type as long as it exhibits the insulating properties. For example, the covering insulating layer 160 may contain a resin (That is, it may be a resin layer.), and the resin may be either a thermosetting resin or a thermoplastic resin. That is, the covering material may be a resin layer (covering resin layer), and in a preferred aspect, the covering material 150 may be constituted by the resin layer (covering resin layer) 160 and the covering inorganic layer 170 provided thereon. The covering insulating layer 160 may include an inorganic filler. By way of example only, the covering insulating layer 160 may be made from an epoxy-based resin containing an inorganic filler, such as SiC. The covering inorganic layer 170 is provided so as to cover the covering insulating layer 160. As shown in FIG. 2, the covering inorganic layer 170 is positioned on the covering insulating layer 160, and thus has a form of largely enclosing the solid-state battery 100 on the substrate 200 as a whole together with the covering insulating layer 160. The covering insulating layer 160 forms a suitable water vapor barrier together with the covering inorganic layer 170, and the covering inorganic layer 170 forms a suitable water vapor barrier together with the covering insulating layer 160. The material of the covering inorganic layer 170 is not particularly limited, and may be metal, glass, oxide ceramics, a mixture thereof, or the like. The covering inorganic layer 170 may be an inorganic film. That is, the covering inorganic layer 170 may correspond to an inorganic layer having a thin film form, and is, for example, a metal film. Although it is merely one example, the covering inorganic layer 170 may be formed of a plated Cu-based and/or Ni-based material having a thickness of 2 μm to 50 μm.

In the solid-state battery package 1000 of the present invention, the substrate 200 may be a packaging member provided so as to support the solid-state battery 100. That is, the substrate 200 provided more proximal to one main surface side (the main surface opposite to the main surface forming a top surface) of the solid-state battery 100 may be a support substrate. As shown in FIG. 2, the substrate 200 has a main surface larger than, for example, the solid-state battery 100. Further, the substrate 200 may be a resin substrate. Alternatively, the substrate 200 may be a ceramic substrate. In short, the substrate 200 may belong to a printed circuit board, a flexible substrate, an LTCC substrate, an HTCC substrate, or the like.

The substrate 200 preferably serves as a member for an external terminal of the packaged solid-state battery. That is, the substrate 200 may be a terminal substrate for the external terminal of the solid-state battery 100. The solid-state battery package including such a substrate allows the solid-state battery to be mounted on another external board (that is, a secondary substrate) such as a printed wiring board, with the substrate interposed therebetween. For example, the solid-state battery can be mounted over a surface with the substrate interposed therebetween, through solder reflow and the like. For the reasons described above, the solid-state battery package according to the present invention is preferably a surface-mount-device (SMD) type battery package.

Because of being a terminal substrate, the substrate preferably includes wiring and/or an electrode layer. In particular, the substrate may include an electrode layer that electrically connects the upper and lower main surfaces. The substrate 200 according to a preferred aspect includes electrode layers (upper main surface electrode layers 210 and lower main surface electrode layers 220) that electrically connects the upper and lower main surfaces of the substrate, and serves as a member for the external terminal of the packaged solid-state battery (see FIG. 2). In the solid-state battery package including such a substrate, the electrode layers of the substrate and terminal parts of the solid-state battery are connected to each other. Preferably, the electrode layers of the substrate and the end-face electrodes of the solid-state battery are electrically connected to each other. For example, the end-face electrode 140A on the positive-electrode side of the solid-state battery is electrically connected to the electrode layers (210A, 220A) on the positive-electrode side of the substrate, while the end-face electrode 140B on the negative-electrode side of the solid-state battery is electrically connected to the electrode layers (210B, 220B) on the negative-electrode side of the substrate. Thus, the positive-electrode-side and negative-electrode-side electrode layers (in particular, the electrode layers located on the lower side/bottom side of the packaged product, or lands connected thereto) of the substrate are provided respectively as a positive electrode terminal and a negative electrode terminal for the solid-state battery package.

The solid-state battery package 1000 of the present invention has a form in which a water vapor barrier layer 300 is interposed between the solid-state battery 100 and the substrate 200 so as to suitably provide a barrier characteristic for preventing moisture infiltration into the solid-state battery (see FIG. 2). The term “barrier” as used herein means having a property of blocking water vapor transmission so that water vapor in the external environment causes no undesirable characteristic deterioration for the solid-state battery. In a narrow sense, the term “barrier” in the present specification means that the water vapor transmission rate is less than 5×10⁻³ g/(m²·Day). In short, the water vapor barrier layer preferably has a water vapor transmission rate of 0 g/(m²·Day) to less than 5×10⁻³ g/(m²·Day) (for example, may have 0.5×10⁻³ g/(m²·Day) to less than 5×10⁻³ g/(m²·Day), or the like.). Note that the term “water vapor transmission rate” mentioned herein refers to a transmission rate obtained by the MA method under measurement conditions of 85° C. and 85% RH using a gas transmission rate measuring device of model WG-15S manufactured by MORESCO Corporation.

As illustrated in FIG. 2, the water vapor barrier layer 300 may be provided so as to be in contact with the covering insulating layer 160. That is, the covering insulating layer 160 is preferably provided so as to cover not only the side surface of the solid-state battery 100 but also the lower surface of the solid-state battery 100, and the water vapor barrier layer 300 may be provided so as to be in contact with the covering insulating layer 160 that covers the side surface and/or the lower surface of the solid-state battery 100. This means that the water vapor barrier layer is provided between the sealing resin surrounding the periphery of the solid-state battery and the substrate. When a resist layer 400 is provided on the substrate 200 (an aspect of resist layer installation will be described later), the water vapor barrier layer 300 may be disposed between the covering insulating layer 160 and the resist layer 400.

In a preferred aspect, the water vapor barrier layer is thinner than a layer constituting the solid-state battery. That is, as shown in FIG. 3, the thickness of the water vapor barrier layer 300 located between the solid-state battery 100 and the substrate 200 may be smaller than the layer thickness of layers 110, 120, and 130 (for example, at least one layer thereof) constituting the stacked structure of the solid-state battery. In other words, the water vapor barrier layer may be smaller than the layer thickness of the positive electrode layer, smaller than the layer thickness of the negative electrode layer, and/or smaller than the layer thickness of the solid electrolyte layer. In another preferred aspect, the water vapor barrier layer is thinner than each layer constituting the substrate. That is, as shown in FIG. 3, the thickness of the water vapor barrier layer 300 located between the solid-state battery 100 and the substrate 200 may be smaller than the layer thickness of a layer 200′ (for example, at least one layer thereof) forming the stacked structure of the substrate 200. For example, the water vapor barrier layer may be smaller than the layer thickness of a metal layer included in the substrate, may be smaller than the layer thickness of each resin layer constituting the substrate when the substrate is a resin substrate, and may be smaller than the layer thickness of each ceramic layer constituting the substrate when the substrate is a ceramic substrate. When the water vapor barrier layer is relatively thinner than various constituent layers of the solid-state battery package as described above, undesirable water vapor transmission can be prevented with a design that does not contradict reduction in height or size of the solid-state battery package. That is, while preventing the water vapor transmission, the influence thereof on the others is suppressed. The water vapor barrier layer may have, for example, a film form.

Here, the term “layer constituting the stacked structure of the solid-state battery” used in the present specification means a layer forming a battery constituent unit of the solid-state battery in a broad sense, and refers to any layer of the positive electrode layer, the negative electrode layer, and the solid electrolyte layer therebetween in a narrow sense. For example, the water vapor barrier layer is thinner than the battery electrode layers such as the positive electrode layer and/or the negative electrode layer of the solid-state battery, and/or the water vapor barrier layer is thinner than the solid electrolyte layer of the solid electrolyte layer.

In addition, the term “layer constituting the substrate” used in the present specification means, for example, each layer assumed when the substrate is constituted by stacking. Taking a resin substrate as an example, in a case where the substrate is formed, in a macroscopic view, by stacking a resin layer (for example, a layer including a resin material impregnated into a base material such as a glass fiber cloth) and a metal layer, each layer such as the resin layer and/or the metal layer corresponds to a “layer constituting the substrate”. In addition, in a ceramic substrate, when the substrate is formed, in a macroscopic view, by stacking a ceramic layer and other metal layers, each layer such as the ceramic layer and the metal layer corresponds to a “layer constituting the substrate”.

The thickness of each layer of the water vapor barrier layer, the solid-state battery, and the substrate may be based on an electron microscopic image. For example, the thickness of the water vapor barrier layer and the thickness of the layers constituting the substrate and the solid-state battery may be based on an image obtained by cutting out the cross section with an ion milling apparatus (model number IM 4000 PLUS; manufactured by Hitachi High-Tech Corporation) and using a scanning electron microscope (SEM) (model number SU-8040; manufactured by Hitachi High-Tech Corporation). That is, the thickness dimension in the present specification may refer to a value calculated from a dimension measured from an image acquired by such a method.

In the solid-state battery package, the water vapor barrier layer may extend along the surface direction of the substrate. As shown in the sectional view of FIGS. 1 to 3, the water vapor barrier layer 300 may extend in the width direction of the solid-state battery package 1000, and may extend across the solid-state battery package. The term “extend along the surface direction” as used herein means extending in a direction parallel to the main surface of the substrate. That is, it can be said that the water vapor barrier layer extends in a direction orthogonal to the stacking direction of the solid-state battery. Preferably, the water vapor barrier layer extends in all directions (all directions) orthogonal to the “stacking direction of the solid-state battery”. The water vapor barrier layer extending widely in the surface direction of the substrate as described above can more suitably prevent water vapor infiltrating from the external environment via the substrate. That is, the water vapor barrier layer can more suitably act so that water vapor infiltrating from the outside of the package does not finally reach the solid-state battery, and as a result, a suitable solid-state battery package in which deterioration of solid-state battery characteristics is suppressed in a longer term can be obtained.

It is preferable that the water vapor barrier layer extending along the surface direction of the substrate is provided widely to the outer region of the solid-state battery. That is, it is preferable that the water vapor barrier layer is provided over a wide range so as to protrude from the installation region of the solid-state battery. In this regard, the water vapor barrier layer may extend to the peripheral edge of the solid-state battery package, and for example, the water vapor barrier layer may extend to the covering material that covers the solid-state battery package. It can be said that the water vapor barrier layer may extend (particularly extend in the surface direction of the substrate) such that the outer peripheral edge (preferably the outer peripheral edge as a whole) of the water vapor barrier layer reaches the outer peripheral edge of the solid-state battery package.

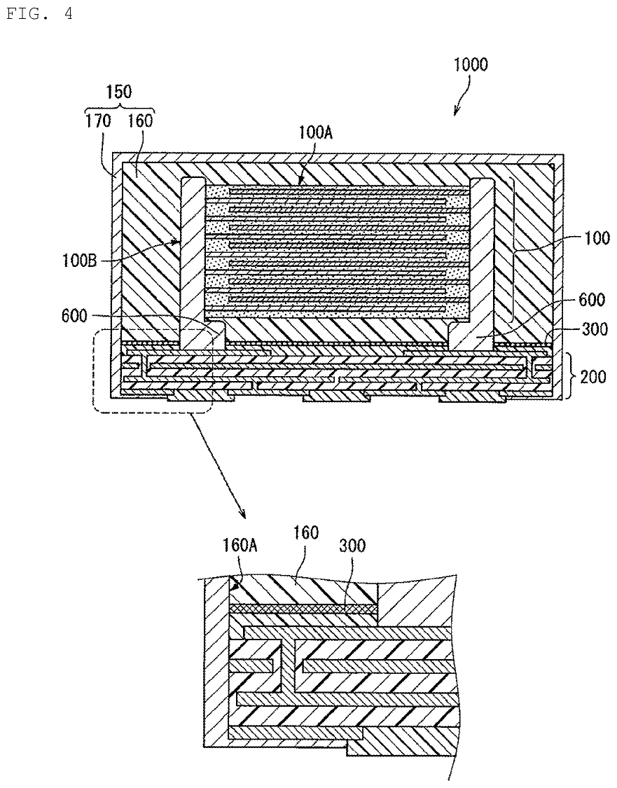

For example, the water vapor barrier layer may extend to the outer surface of the covering insulating layer that covers the solid-state battery on the substrate. That is, when the solid-state battery package 1000 has the covering insulating layer 160 provided on the substrate 200 so as to cover at least the top surface 100A and the side surface 100B of the solid-state battery 100, the water vapor barrier layer 300 preferably extends to the outer surface 160A of the covering insulating layer 160 that covers the side surface 100B (see FIG. 4). As can be seen from the sectional view of FIG. 4, this is because water vapor infiltrating from the external environment via the substrate 200 can be more reliably prevented. That is, the water vapor barrier layer can more reliably act so that external water vapor infiltrating through the substrate does not reach the solid-state battery, and a more suitable solid-state battery package in which deterioration of solid-state battery characteristics is suppressed in a longer term is provided.

In a preferred aspect, the water vapor barrier layer is an insulating film. That is, the water vapor barrier layer is an insulating film or an insulating layer having electrical insulation properties. In this regard, the water vapor barrier layer may be a film including a material having a high electrical insulation property. The term “insulation” as used herein may have an electrical resistivity, that is, the insulation property of a general insulator, and may have a resistivity of at least 1.0×10³ Ω·m or more, preferably 1.0×10⁶ Ω·m or more, and more preferably 1.0×10⁷ Ω·m or more (room temperature: 20° C.) although it is merely an example. This is because a disadvantageous phenomenon such as short circuit can be more suppressed. That is, it is possible to prevent the water vapor transmission and also suitably suppress an electrically disadvantageous influence thereof and the like. The film or layer of such a water vapor barrier is not particularly limited as long as it is a material exhibiting an insulating property. Specific examples of such a material include an inorganic insulator such as glass or alumina, an organic insulator such as a resin, and the like, and these materials may be used alone or in combination of two or more thereof. For example, the water vapor barrier layer may be an inorganic film containing an inorganic material, or may be an insulating film exhibiting electrical insulation properties in terms of the inorganic material. Alternatively, the water vapor barrier layer may be an organic film containing an organic material, or may be an insulating film having electrical insulation properties in terms of the organic material. Furthermore, such an inorganic material and an organic material may be combined to form a film. Note that the term “film” or “thin film” in the present specification refers to a form having a small layer thickness, and for example, can be understood to refer to having “nanometer order thickness” (10 nm to 900 nm) described later.

The water vapor barrier layer may have a single layer form. Alternatively, the water vapor barrier layer may have a form including a plurality of layers (that is, a multilayer form described below). There is no particular limitation on the form as long as desired water vapor transmission preventing properties are provided.

In a preferred embodiment, the water vapor barrier layer is an insulating multilayer film. The water vapor barrier property of the water vapor barrier layer can be improved by multilayering. In such an insulating multilayer film, the same film (for example, a film made of the same material) may be formed a plurality of times, or different films (for example, films made of materials different from each other) may be formed. In the case of different films, an organic insulating barrier layer may be formed on the inorganic insulating barrier layer.

In a preferred aspect, the water vapor barrier layer is provided so as to substantially largely occupy the plan view area of the solid-state battery package. Specifically, the water vapor barrier layer may be provided so as to occupy the whole region of the plan view region of the solid-state battery package except for the connection region (that is, the connection portion) between the end-face electrode of the solid-state battery and the electrode layer on the main surface of the substrate. As described above, the water vapor barrier layer having a large area in plan view can more reliably prevent water vapor infiltrating from the external environment through the substrate. The water vapor barrier layer 300 of such an aspect may extend at the height level of the bonding member 600 provided between the end-face electrode and the electrode layer of the substrate main surface (see FIG. 4). For example, in a sectional view, the water vapor barrier layer 300 may extend so as to be interposed by the bonding member 600, as well as, so as to be crossing the bonding member. In a sectional view, it can be said that the water vapor barrier layer 300 may extend so as to be in contact with the bonding member 600, and may extend beyond the bonding member to be in contact with the outer surface 160A of the covering insulating layer on the outer side. The bonding member 600 at least serves for electrical connection between the end-face electrode of the solid-state battery and the substrate, and may include, for example, a conductive adhesive (Although it is merely an example, the bonding member 600 may be made of an epoxy-based conductive adhesive containing a metal filler such as Ag.).

The water vapor barrier layer is preferably a layer containing silicon. This is because the layer tends to be suitable in terms of electrical insulation. For example, the water vapor barrier layer may be an inorganic layer or an inorganic film containing silicon. The water vapor barrier layer containing silicon may be a layer composed of a molecular structure containing not only silicon atoms but also nitrogen atoms and/or oxygen atoms. This is because the layer tends to be suitable in terms of electrical insulation and thinning. For example, the water vapor barrier layer has both an Si—O bond and an Si—N bond. That is, for the water vapor barrier layer, both an Si—O bond and an Si—N bond may exist in the molecular structure constituting the layer material. When the molecular structure of the layer has both an Si—O bond and an Si—N bond, the layer tends to be a dense layer though it is a thin layer, and tends to be a water vapor barrier layer more suitably exhibiting characteristics of water vapor transmission prevention. In other words, the water vapor barrier layer is not only desirable in terms of electrical insulation property and thinning, but also easily becomes a water vapor barrier layer exhibiting more suitable water vapor transmission preventing property. This means that while water vapor transmission prevention is suitably achieved, adverse effects (in particular, adverse effects from the viewpoint of height reduction and/or size reduction of the solid-state battery package and/or from the electrical viewpoint, and the like) caused thereby can be suppressed. The above “water vapor barrier layer containing silicon” and “water vapor barrier layer having both an Si—O bond and an Si—N bond” are not based on siloxane. That is, the water vapor barrier layer according to the present invention preferably has a molecular structure containing silicon or an Si—O bond but not containing a siloxane skeleton.

As used herein, the term “Si—O bond” and “Si—N bond” refer to those that can be confirmed, for example, based on Fourier transform infrared spectroscopy (FT-IR). That is, in the water vapor barrier layer according to the aspect, the Si—O bond and the Si—N bond can be confirmed by measuring the light absorption in the infrared region. In the present specification, FT-IR refers to, for example, those measured by the microscopic ATR method using Spotlight 150, which is manufactured by PerkinElmer Inc.

In terms of thin film form, the water vapor barrier layer having an Si—O bond and an Si—N bond is, for example, a film thinner than each layer constituting the stacked structure of the solid-state battery and/or a film thinner than each layer constituting the substrate. Therefore, the water vapor transmission can be suitably prevented with a design that does not contradict the reduction in height or size of the solid-state battery package. For example, the water vapor barrier layer having an Si—O bond and an Si—N bond preferably has a thickness in nanometer order, and is preferably 10 nm to 900 nm, more preferably 50 nm to 700 nm, still more preferably 50 nm to 500 nm, for example, 50 nm to 400 nm, 50 nm to 300 nm, or 100 nm to 300 nm.

In addition, the water vapor barrier layer having an Si—O bond and an Si—N bond can be a layer having relatively high toughness. This means that the water vapor barrier layer can suitably act during charging and discharging of the solid-state battery. When the solid-state battery is charged and discharged, ions move between the positive and negative electrode layers through the solid electrolyte layer, and thereby the solid-state battery may expand and contract. However, when subjected to such a stress of expansion and contraction, the water vapor barrier layer, having high toughness, is less likely to be cleaved and/or cracked. Usually, a layer having a high water vapor barrier property may be densely hard and have a tendency to be easily cleaved and/or cracked due to stress or the like, whereas a layer having a relatively soft property without being cleaved and/or cracked may have a tendency to have a low water vapor barrier property. In this respect, the water vapor barrier layer containing an Si—O bond and an Si—N bond according to the present invention becomes a layer that is less likely to be cleaved or cracked when subjected to stress of expansion and contraction by the solid-state battery, but is excellent in water vapor permeability, increasing in reliability as a solid-state battery package.

The water vapor barrier layer according to the present invention may include, for example, an SiON and/or SiNH site in its molecular structure. That is, the water vapor barrier layer having an Si—O bond and an Si—N bond may contain SiON and/or SiNH. In addition, the water vapor barrier layer having an Si—O bond and an Si—N bond may have a molecular concentration or atomic concentration differing in the thickness direction. For example, more SiNH may be formed in the in-layer region on the relatively lower side, while more SiON may be formed in the in-layer region on the relatively upper side. In other words, in the water vapor barrier layer provided between the substrate and the solid-state battery, the in-layer region on the relatively upper side (that is, the side relatively proximal to the solid-state battery) may contain a relatively large amount of Si—O bonds, and the in-layer region on the relatively lower side (that is, the side relatively proximal to the substrate) may contain a relatively large amount of Si—N bonds. For example, more Si—O bonds may be contained in the upper half region of the water vapor barrier layer (upper half region relatively proximal to the solid-state battery), while more Si—N bonds may be contained in the lower half region of the water vapor barrier layer (lower half region relatively proximal to the substrate). That is, in the water vapor barrier layer, the N atom concentration may be relatively high in the in-layer region on the relatively lower side, and the O atom concentration may be relatively high in the in-layer region on the relatively upper side of the water vapor barrier layer. In such a case, the effect of the water vapor barrier layer such as “becomes a layer that is less likely to be cleaved or cracked when subjected to stress of expansion and contraction by the solid-state battery, but is excellent in water vapor permeability” is likely to become apparent. In addition, within the in-layer region having more SiON on the relatively upper side, the oxygen atom concentration may be relatively high on the upper side, and the oxygen atom concentration may be relatively low on the lower side. From such a viewpoint, the water vapor barrier layer (in particular, a water vapor barrier layer having an Si—O bond and an Si—N bond) may be a layer including both an SiON site and an SiNH site as its molecular structure. The water vapor barrier layer including both the SiON site and the SiNH site is a dense layer, and can be a layer excellent in water vapor transmission preventing property.

Preferably, the water vapor barrier layer having Si—O bonds and Si—N bonds is formed from a liquid raw material. Specifically, it is preferable to form the water vapor barrier layer having both an Si—O bond and an Si—N bond by applying the liquid raw material to the substrate and subjecting the substrate to light irradiation. As a result, the water vapor barrier layer can be formed without being subjected to a higher temperature, and the adverse thermal influence on the substrate can be suppressed. In addition, the vacuum vapor deposition method and the like generally require an expensive vapor deposition apparatus, but formation using such a liquid raw material does not require such an expensive apparatus, and also relatively suppresses the cost. Furthermore, although a layer formed by a vacuum vapor deposition method or the like may cause warpage of the substrate due to stress acting on the layer, the layer formed from a liquid raw material as described above has little or substantially no such stress. Therefore, when the water vapor barrier layer is produced from the liquid raw material, the possibility that the substrate warps is reduced or prevented.

The solid-state battery package of the present invention can be embodied in various aspects. For example, the following aspects may be considered.

(Aspect of Resist Installation)

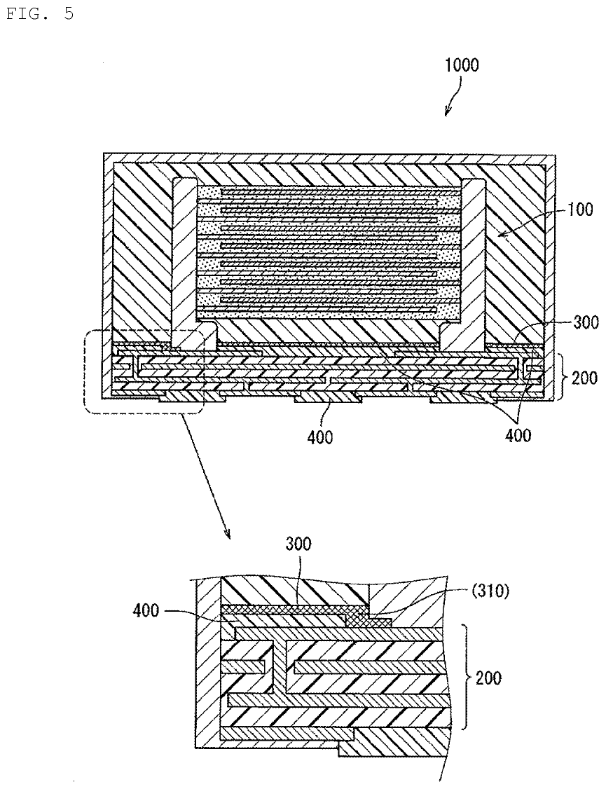

The aspect has a form in which a resist layer is disposed between the substrate and the solid-state battery. In particular, due to the resist present on the substrate 200, the solid-state battery package 1000 may have a resist layer 400 between the substrate 200 and the solid-state battery 100 (see FIG. 5).

The resist layer 400 is particularly provided on the main surface of the substrate 200. The resist layer is a layer that at least partly covers the substrate surface in order to keep away physical processing or chemical reaction. Therefore, the resist layer may be an insulating layer including a resin material provided on the main surface of the substrate 200. Such a resist layer can also be regarded as corresponding to a heat-resistant coating provided on the main surface of the substrate 200. For example, the resist may be used to maintain insulation at the time of connection between the solid-state battery and the substrate and to protect a conductor portion such as the electrode layers of the substrate. The resist layer 400 provided on the main surface of the substrate 200 may be a so-called “solder resist” layer.

When the solid-state battery package has a resist layer, the water vapor barrier layer may have a barrier property higher than that of the resist layer. For example, when the resist layer 400 is provided on the substrate 200, the water vapor barrier layer 300 preferably has a water vapor transmission rate lower than that of the resist layer 400. It is because: for example, although the resist layer made of a solder resist is not necessarily sufficient in terms of water vapor transmission prevention, it is possible to more preferably prevent water vapor infiltrating from the external environment via the substrate. For example, when the resist layer is formed of a solder resist containing a resin such as epoxy and/or acrylic, the resist layer can correspond to an insulating layer having a water vapor transmission rate of 1 g/(m²·Day) or more. That is, the water vapor barrier layer may have a water vapor transmission rate lower than that of such an insulating layer (that is, for example, a water vapor transmission rate of 0 g/(m²·Day) to less than 1 g/(m²·Day)).

As shown in FIG. 5, in the solid-state battery package 1000 of the present invention, the resist layer 400 may be provided on the main surface (in particular, the main surface on the side relatively close to the solid-state battery 100) of the substrate 200. In such a case, the water vapor barrier layer 300 may be disposed at least on the resist layer 400. In the aspect illustrated in FIG. 5, the water vapor barrier layer 300 is disposed in direct contact with the resist layer 400 so that the water vapor barrier layer 300 and the resist layer 400 are stacked on each other. When the water vapor barrier layer is provided on the resist layer as described above, water vapor infiltrating from the external environment via the substrate and the resist layer thereon can be more effectively prevented.

When the solid-state battery package has the resist layer, the water vapor barrier layer may also be partly provided on the substrate surface. For example, as illustrated in the extraction diagram of FIG. 5, the water vapor barrier layer 300 on the resist layer 400 may be partly positioned on the substrate 200 (In FIG. 5, the portion of the water vapor barrier layer located on the substrate 200 is indicated as 310.). That is, in a sectional view, the water vapor barrier layer overlapping the resist layer in the stacking direction may extend beyond the resist layer to be partly aligned with the resist layer. When the water vapor barrier layer is partly positioned on the substrate as described above, the water vapor barrier property of the solid-state battery package can be improved. For example, when the substrate is a resin substrate, the boundary portion between the electrode layer of the substrate made of a metal having a high water vapor barrier property and the substrate resin portion having a low water vapor barrier property, and the like can be more reliably covered with the water vapor barrier layer, and the water vapor barrier property of the solid-state battery package can be improved. From such a viewpoint, the water vapor barrier layer provided so as to overlap the resist layer may be partly positioned at least on the electrode of the substrate.

(Aspect 1 of Substrate Metal Layer for Delayed Moisture Transmission)

In the aspect, the substrate has a metal layer as a structure for delayed moisture transmission. That is, the substrate itself of the solid-state battery package has a structure contributing to water vapor transmission prevention.

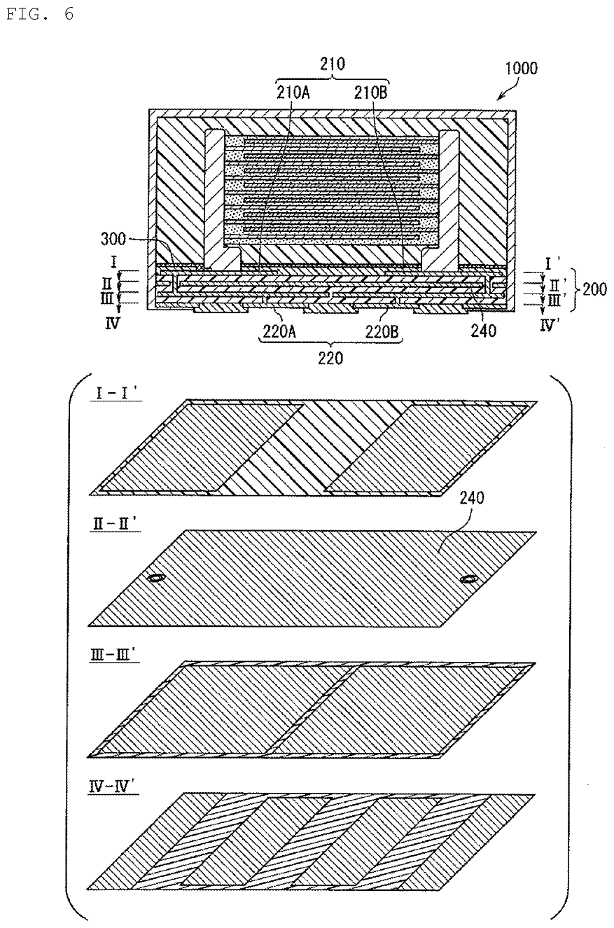

For example, a metal layer 240 is included as a layer constituting the substrate 200, the substrate 200's outer contour in plan view shape overlaps the metal layer 240's outer contour in plan view shape (see FIGS. 6 and 7). That is, the metal layer 240 extends largely and widely up to the peripheral edge of the substrate 200. When the substrate is a resin substrate, it can be said that the metal layer extends to a position exposed to the outer periphery (outermost periphery) of the resin substrate. In a preferred aspect, while the substrate 200's outer contour in plan view shape overlaps the metal layer 240's outer contour in plan view shape, the metal layer 240 has a solid form as a whole (for example, a totally solid form except for the following opening region) as the internal region, which is inside the outer contour.

In the substrate, the metal layer is denser than the resin portion and/or the ceramic portion, and contributes to water vapor transmission prevention. Therefore, water vapor infiltrating from the external environment can be prevented in advance at the substrate portion. That is, in combination with the effect of the water vapor barrier layer, the effect that the infiltration of the external water vapor through the substrate never reaches the solid-state battery becomes more reliable, and a more suitable solid-state battery package in which deterioration of the solid-state battery characteristics is suppressed in a longer term is provided. For example, when the substrate has a metal layer that contributes to delayed moisture transmission, the solid-state battery package may have a water vapor barrier property with a water vapor transmission rate of less than 2.5×10⁻³ g/(m²·Day) (such a lower limit may be 0 g/(m²·Day)).

The metal layer may be, for example, a layer made of at least one metal material selected from the group consisting of copper, aluminum, stainless steel, nickel, silver, gold, tin, and the like. The metal layer may be a metal foil, for example, a copper foil.

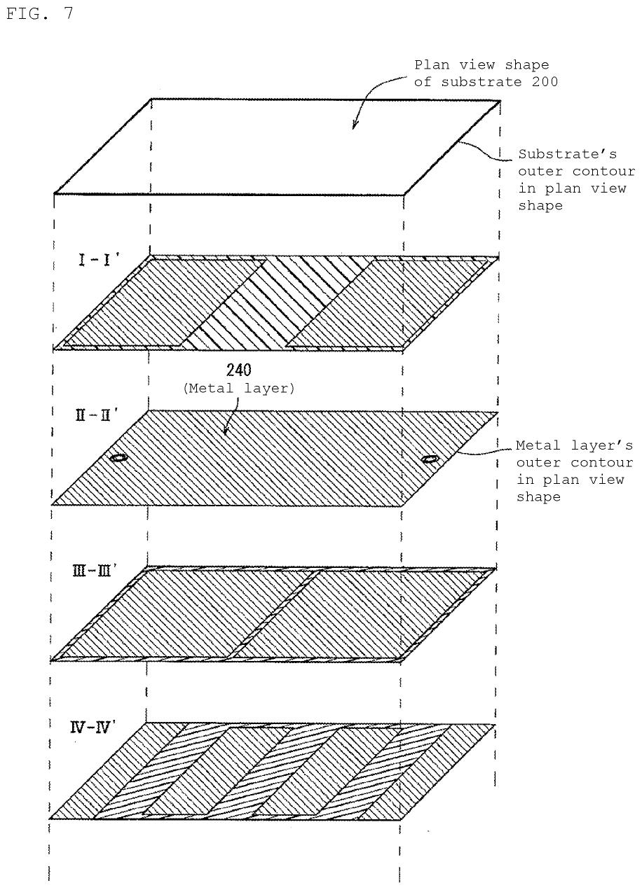

The metal layer may correspond to a layer located inside the substrate. That is, when the substrate has: in one main surface, a first electrode layer that electrically connects with the solid-state battery; and in the other main surface, a second electrode layer with which the solid-state battery package is mounted to an external board, the metal layer is positioned between the first electrode layer and the second electrode layer. For example, the metal layer 240 may be provided in a substrate inner region between the first electrode layer 210 corresponding to a mounting layer of the solid-state battery 100 and the second electrode layer 220 (for example, the second electrode layer 220 corresponding to a so-called customer mounting layer) (see FIG. 6). As described above, since the metal layer can be exclusively provided separately from the electrode layer in order for water vapor transmission prevention, water vapor transmission can be more effectively prevented with the substrate. Note that such a metal layer may or may not play a part in electrical connection between the upper and lower main surfaces of the substrate. When not playing a part in electrical connection between the upper and lower main surfaces of the substrate, the metal layer 240 corresponds to a non-electrically connected metal layer provided in the substrate inner region. That is, the metal layer 240 in such a case is not electrically connected to the first electrode layer 210 or the second electrode layer 220. On the other hand, when playing a part in electrical connection between the upper and lower main surfaces of the substrate, the metal layer 240 corresponds to a metal layer for electrical connection provided in the substrate inner region. That is, the metal layer 240 in such a case is electrically connected to the first electrode layer 210 and the second electrode layer 220. In a preferred aspect, the metal layer may be a dummy electrode layer not playing a part in electrical connection between the upper and lower main surfaces. That is, the metal layer may not be electrically connected to the first electrode layer and the second electrode layer, and may be exclusively provided in order to prevent water vapor transmission. Alternatively, the metal layer may be a ground layer. That is, the metal layer for water vapor transmission prevention may be used as the ground layer. Such a metal layer for water vapor transmission prevention may be one layer, but is not necessarily limited thereto. When more emphasis is placed on further enhancing the effect of water vapor transmission prevention, the metal layer may be provided as at least two layers in the substrate. As illustrated in FIG. 8, when the metal layer 240 is provided in the substrate 200, a substrate base material layer 250 such as a resin layer has a meandering shape in substrate sectional view. That is, the water vapor infiltration path of the substrate becomes a detour shape, and the water vapor transmission to the solid-state battery can be more suitably prevented.

In a preferred aspect, the metal layer extending across the substrate is configured to substantially occupy the planar level of the substrate as a whole. It can also be said that the metal layer provided inside the substrate and extending in the surface direction of the substrate substantially occupies the substrate surface (virtual plane inside the substrate) at such an extension level as a whole. For example, the area of the metal layer 240 in plan view shape is 90% or more, preferably 95% or more, and more preferably 99% or more with respect to the area of the substrate 200 in plan view shape. That is, the metal area ratio in the substrate may be 90% or more, preferably 95% or more, and more preferably 99% or more. The upper limit value of such an area ratio may be 100% (another area ratio/occupancy ratio mentioned in the present specification may also be 100% as an upper limit value). The metal area ratio and the like may be understood to include the metal portion in the opening of the metal layer (for example, via) described later. Although it is merely an example, the area of the metal layer 240 in plan view shape may be 90% to 99.5%, 95% to 99.5%, or the like with respect to the area of the substrate 200 in plan view shape. It can also be said that the substrate surface occupancy ratio of the metal layer extending in the substrate surface direction inside the substrate may be 90% or more, preferably 95% or more, and more preferably 99% or more. This means that the plan view shape of the metal layer 240 and the plan view shape of the substrate 200 are substantially the same in a macroscopic view (see FIG. 7), and therefore it is possible to more reliably prevent water vapor infiltrating from the external environment at the substrate portion.

(Aspect 2 of Substrate Metal Layer for Delayed Moisture Transmission)

In the aspect, the metal layer provided as the structure of delayed moisture transmission of the substrate has a unique opening shape. Specifically, the opening region provided in the metal layer has a circular shape in plan view shape. As illustrated in FIG. 8, in the metal layer 240 largely and widely extending to the peripheral edge of the substrate 200, the plan view shape of the opening region 245 (or the contour in plan view of the opening) may be circular. The circular shape in plan view has little shape anisotropy, and easily contributes to improvement of the metal area ratio. That is, such an opening can improve the metal area ratio in the plan view shape of the substrate, and can further enhance the effect of water vapor transmission prevention. Therefore, it is easy to obtain a long-life solid-state battery package in which deterioration of solid-state battery characteristics is more suitably suppressed in a longer period of time.

For example, the opening region for a via playing a part in electrical connection between the upper and lower main surfaces may have a circular shape in plan view shape. In such a case, the metal portion or the conductive portion being a connection between the upper and lower layers in the substrate is preferably circular (circular in plan view).

The term “circular shape” as used herein is not limited to a perfect circular shape (that is, simply a “circle” or a “perfect circle”), and includes a substantially circular shape that can be usually included in a “round shape” as recognized by those skilled in the art while being changed from the perfect circular shape. For example, not only a circle or a perfect circle but also a circle whose arc has a locally different curvature may be used, and furthermore, a circle such as an ellipse or a shape derived from a perfect circle may be used.

Note that the term “metal area ratio” may be considered to include the metal region of the via portion. That is, in the metal layer having the opening region, the area of the metal layer in plan view shape may be 90% or more, preferably 95% or more, and more preferably 99% or more, including the area of the via located in the opening region (the area of the plan view shape of the via on the same plane as the metal layer).

(Aspect of Resin Substrate)

In the aspect, the substrate is particularly a resin substrate. That is, the solid-state battery package includes a substrate including a resin as a base material. In the aspect, a resin layer may be included in the stacked structure of the substrate. The resin material of such a resin layer may be any thermoplastic resin and/or any thermosetting resin. The resin layer may be formed by impregnating a fiber cloth and/or paper as a substrate with a resin material. For example, it may be formed by impregnating a glass fiber cloth with a resin material such as an epoxy resin.

The resin substrate can suitably act during charging and discharging of the solid-state battery. When the solid-state battery is charged and discharged, ions move between the positive and negative electrode layers through the solid electrolyte layer, and thereby the solid-state battery may expand and contract. However, the resin substrate can suitably absorb the stress at the time of charging and discharging, and the load on the water vapor barrier layer may be reduced. That is, the possibility that the water vapor barrier layer is impaired during use of the solid-state battery package is reduced, and the reliability of the package can be improved in terms of water vapor transmission prevention.

The inventor of the present application has found that the resin exhibits considerable permeability to water vapor (various forms of moisture including, for example, water vapor in the air), and in the solid-state battery package, moisture may infiltrate the inner part of the package through the resin portion of the substrate. Therefore, when the substrate is a resin substrate, the effect of the substrate metal layer with delayed moisture transmission, that is, the metal layer that more reliably blocks water vapor from the external environment at the substrate site, and the like tend to become apparent.

[Method for Manufacturing Solid-State Battery Package]

The packaged product according to the present invention can be obtained through a process of preparing a solid-state battery that includes a battery constituent unit including a positive electrode layer, a negative electrode layer, and a solid electrolyte between the electrodes and next packaging the solid-state battery.

The manufacture of the solid-state battery package according to the present invention can be roughly divided into: manufacturing a solid-state battery itself (hereinafter, also referred to as an “unpackaged battery”) corresponding to a stage prior to packaging; preparing a substrate; and packaging.

<<Method for Manufacturing Unpackaged Battery>>

The unpackaged battery can be manufactured by a printing method such as screen printing, a green sheet method with a green sheet used, or a combined method thereof. More particularly, the unpackaged battery itself may be fabricated in accordance with a conventional method for manufacturing a solid-state battery (thus, for raw materials such as the solid electrolyte, organic binder, solvent, optional additives, positive electrode active material, and negative electrode active material described below, those for use in the manufacture of known solid-state batteries may be used).

Hereinafter, for better understanding of the present invention, one manufacturing method will be exemplified and described, but the present invention is not limited to this method. In addition, the following time-dependent matters such as the order of descriptions are merely considered for convenience of explanation and are not necessarily bound by the matters.

(Formation of Stack Block)

The solid electrolyte, the organic binder, the solvent, and optional additives are mixed to prepare a slurry. Then, from the prepared slurry, sheets including the solid electrolyte are formed by firing.

The positive electrode active material, the solid electrolyte, the conductive material, the organic binder, the solvent, and optional additives are mixed to prepare a positive electrode paste. Similarly, the negative electrode active material, the solid electrolyte, the conductive material, the organic binder, the solvent, and optional additives are mixed to prepare a negative electrode paste.

The positive electrode paste is applied by printing onto the sheet, and a current collecting layer and/or a negative layer are applied by printing, if necessary. Similarly, the negative electrode paste is applied by printing onto the sheet, and a current collecting layer and/or a negative layer are applied by printing, if necessary.

The sheet with the positive electrode paste applied by printing and the sheet with the negative electrode paste applied by printing are alternately stacked to obtain a stacked body. Further, the outermost layer (the uppermost layer and/or the lowermost layer) of the stacked body may be an electrolyte layer, an insulating layer, or an electrode layer.

(Formation of Battery Fired Body)

The stacked body is integrated by pressure bonding, and then cut into a predetermined size. The cut stacked body obtained is subjected to degreasing and firing. Thus, a fired stacked body is obtained. The stacked body may be subjected to degreasing and firing before cutting, and then cut.

(Formation of End-face Electrode)

The end-face electrode on the positive electrode side can be formed by applying a conductive paste to the positive electrode-exposed side surface of the fired stacked body. Similarly, the end-face electrode on the negative electrode side can be formed by applying a conductive paste to the negative electrode-exposed side surface of the fired stacked body. The end-face electrodes on the positive electrode side and the negative electrode side may be provided so as to extend to the main surface of the fired stacked body. This is because it is possible to connect to the main surface electrode layer of the substrate in a small area in the next step (More specifically, the end-face electrode provided so as to extend to the main surface of the fired stacked body has a folded portion on the main surface, and such a folded portion can be electrically connected to the main surface electrode layer of the substrate.). The component for the end-face electrode can be selected from at least one selected from silver, gold, platinum, aluminum, copper, tin, and nickel.

Further, the end-face electrodes on the positive electrode side and the negative electrode side are not limited to being formed after firing the stacked body, and may be formed before the firing and subjected to simultaneous firing.

By carrying out the steps as described above, a desired unpackaged battery can be finally obtained.

<<Preparation of Substrate>>

(Resin Substrate)

When the substrate is a resin substrate, it may be prepared by stacking a plurality of layers and performing heating and pressure treatment. For example, at least one resin sheet constituted by impregnating a fiber cloth and/or paper as a base material with a resin raw material and at least one metal sheet (for example, a metal foil sheet) are prepared, and stacked with each other to form a substrate precursor. Then, the substrate precursor is subjected to heating and pressurization in a press machine to obtain a resin substrate.

The main surface electrode layer provided on the main surface of the substrate to be electrically connected may be appropriately subjected to patterning processing.

When the “substrate metal layer with delayed moisture transmission” is provided, a sheet having a desired shape may be included as the metal sheet. The metal sheet including at least a sheet for delayed moisture transmission is alternately stacked with the resin sheet to form a substrate precursor, and the substrate precursor is subjected to heating and pressurization treatment, whereby a resin substrate including a metal layer for delayed moisture transmission can be obtained.

(Ceramic Substrate)

When the substrate is a ceramic substrate, it may be prepared, for example, by stacking and firing a plurality of green sheets.

The ceramic substrate may have vias and/or lands. In such a case, for example, holes may be formed in the green sheet with a punch press, a carbon dioxide laser, or the like, and the holes may be filled with a conductive paste material; or through performing a printing method or the like, the precursor of a metal portion or a conductive portion such as a via, a land, a wiring layer, and/or an electrode layer may be formed. In addition, the ceramic substrate preferably includes a non-connected metal layer, which is not electrically connected, as a water vapor transmission prevention layer. In such a case, the metal layer (particularly, a precursor thereof) may be formed on the green sheet. Such a metal layer may be formed by a printing method, or may be formed by disposing a metal foil or the like. Subsequently, a predetermined number of such green sheets are stacked and thermocompression bonded to form a green sheet laminate, and the green sheet laminate is subjected to firing, whereby the ceramic substrate can be obtained. Further, lands and the like can also be formed after firing the green sheet laminate.

By carrying out the steps as described above, a desired substrate can be finally obtained.

(Formation of Water Vapor Barrier Layer)

Further, the substrate may have a water vapor barrier layer having been formed thereon. More particularly, the water vapor barrier may be formed on the substrate, prior to the packaging, where the substrate and the solid-state battery are combined with each other.

The water vapor barrier layer is not particularly limited as long as a desired barrier layer can be formed. For example, in the case of the “water vapor barrier layer having an Si—O bond and an Si—N bond”, the water vapor barrier layer is formed through application of a liquid raw material and ultraviolet irradiation. Preferably, the “water vapor barrier layer having an Si—O bond and an Si—N bond” can be obtained by irradiating with ultraviolet irradiation a precursor layer obtained by applying a liquid raw material containing a silicon compound, for example, a liquid raw material containing a silicon compound containing an Si—N—Si bond and a solvent (for example, an organic solvent). That is, the water vapor barrier layer is formed from the liquid raw material under relatively low temperature conditions (for example, a temperature condition of about 100° C.) without using a vapor deposition method such as CVD or PVD.

Specifically, a raw material containing a silicon compound such as silazane is prepared as a liquid raw material, and the liquid raw material is applied to the substrate by spin coating, spray coating, or the like, and dried to form a barrier precursor. Then, by subjecting the barrier precursor to UV irradiation under an atmosphere containing nitrogen and/or oxygen, the “water vapor barrier layer having an Si—O bond and an Si—N bond” can be obtained. For example, the “water vapor barrier layer having: an in-layer region that is relatively proximal to the solid-state battery, the in-layer region containing a relatively larger amount of the Si—O bond; and an in-layer region that is relatively proximal to the substrate, the in-layer region containing a relatively larger amount of the Si—N bond” can be obtained by subjecting a barrier precursor layer containing a silicon compound containing an Si—N—Si bond (for example, silazane) to UV irradiation under an ambient atmosphere containing nitrogen and oxygen. In particular, in the step of irradiating the barrier precursor layer with UV, active oxygen is generated in the ambient atmosphere by the UV irradiation, and the active oxygen infiltrates from the outer surface of the barrier precursor layer, whereby the water vapor barrier layer can be obtained. More specifically, active oxygen is generated in an ambient atmosphere containing oxygen and nitrogen, and UV irradiation is continued to promote cleavage of a molecular bond of the “silicon compound containing an Si—N—Si bond” in the barrier precursor layer, whereby active oxygen that has infiltrated from the outer surface of the barrier precursor layer is bonded to the cleaved molecular site. The outer surface of the barrier precursor layer and the in-layer region proximal thereto contain a relatively large amount of Si—O bonds, whereas the in-layer region relatively distal to the outer surface of the barrier precursor layer contains a relatively large amount of Si—N bonds because the influence of UV irradiation is relatively small and the cleavage of the molecular bonds is hardly promoted. By obtaining the water vapor barrier layer on the substrate in this way, it is possible to obtain the “water vapor barrier layer having: an in-layer region that is relatively proximal to the solid-state battery, the in-layer region containing a relatively larger amount of the Si—O bond; and an in-layer region that is relatively proximal to the substrate, the in-layer region containing a relatively larger amount of the Si—N bond”.

In the formation of the water vapor barrier layer, in order that the water vapor barrier layer is not present at the bonding site of the conductive portion of the substrate and the end-face electrode of the solid-state battery, it is preferable to locally remove the barrier layer at the site. Alternatively, a mask may be used such that the water vapor barrier layer is not formed at the bonding site. More particularly, the water vapor barrier layer may be totally formed with a mask applied to the region for the bonding site, and then the mask may be removed.

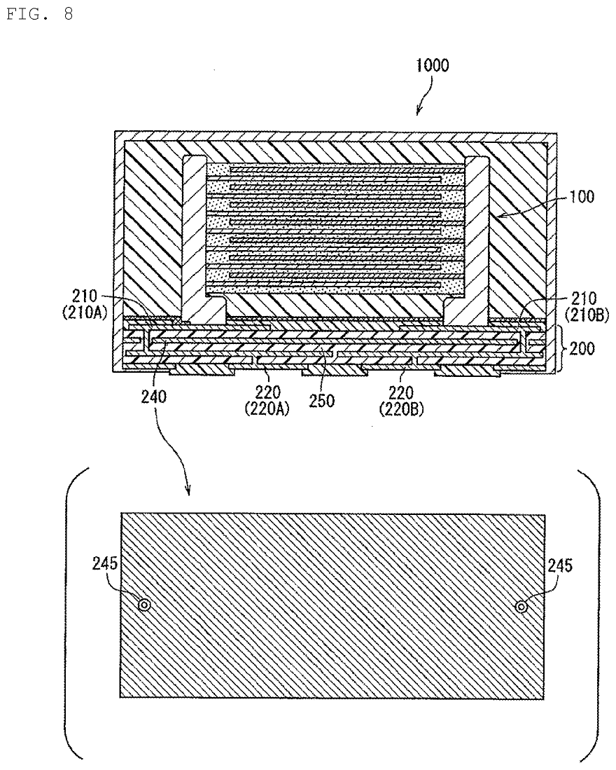

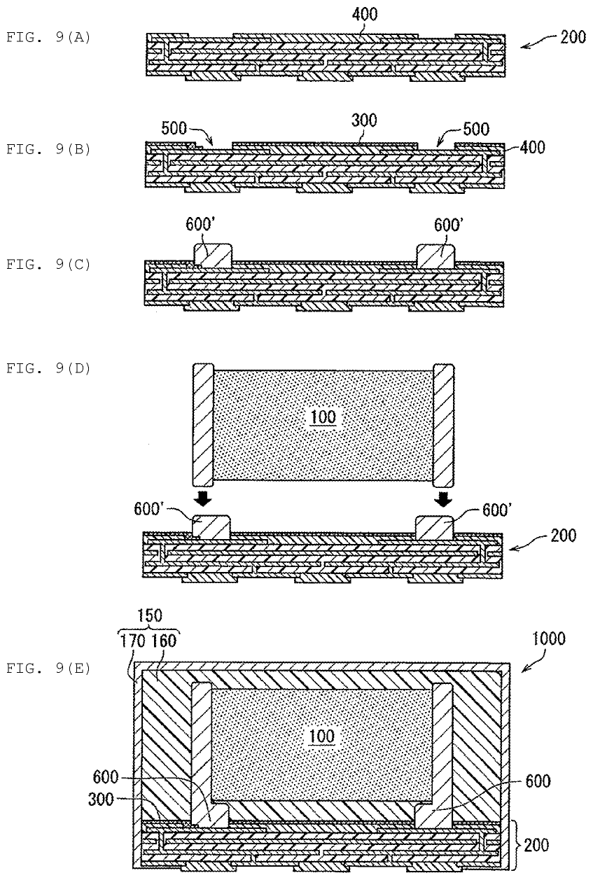

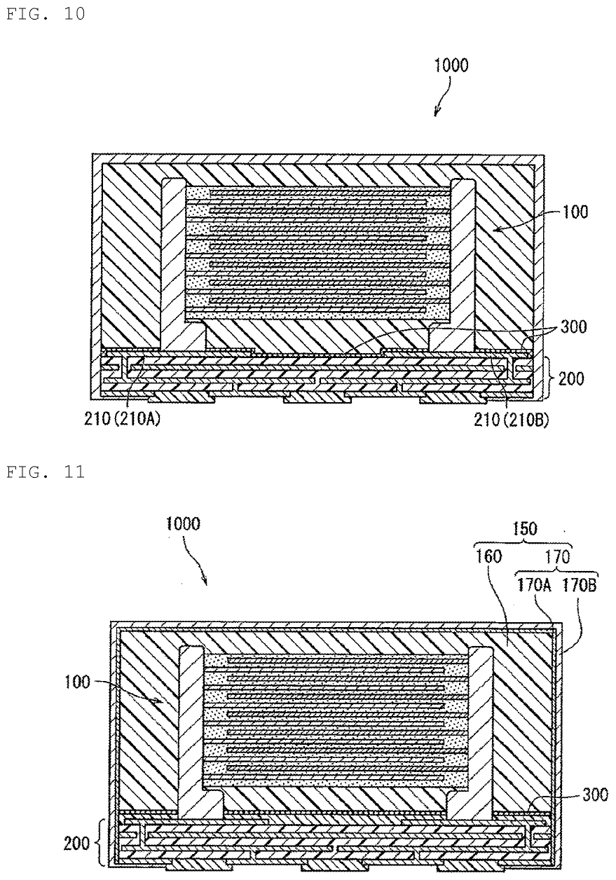

When the resist layer is provided on the main surface of the substrate, the water vapor barrier layer 300 may be formed on the resist layer 400 as illustrated in FIGS. 9(A) and 9(B). At this time, as described above, it is preferable to form the water vapor barrier layer 300 so as to exclude a bonding region 500 with the solid-state battery 100. That is, it is preferable to prepare the substrate 200 on which the resist layer 400 and the water vapor barrier layer 300 are formed so that the surface electrode of the substrate is exposed. If necessary, the water vapor barrier layer may be formed on the resist layer so that a part of the water vapor barrier layer is positioned on the surface electrode of the substrate.

<<Packaging>>

In packaging, the battery and the substrate obtained above are used. FIGS. 9(C) to (E) schematically illustrate the steps of obtaining the solid-state battery package of the present invention by packaging.

First, as shown in FIGS. 9(C) and 9(D), the unpackaged battery 100 is disposed on the substrate 200. More particularly, the “unpackaged solid-state battery” is placed on the substrate (hereinafter, the battery used for packaging is also simply referred to as a “solid-state battery”).

Preferably, the solid-state battery is placed on the substrate so as to electrically connect the conductive parts of the substrate and the end-face electrodes of the solid-state battery to each other. For example, a conductive paste may be provided on the substrate (in particular, the conductive paste may be provided for the region of the “bonding site”), so that the conductive portion of the substrate and the end-face electrode of the solid-state battery are electrically connected to each other. More specifically, alignment is performed such that the electrode layer on the main surface of the substrate is consistent with the folded portion of the end-face electrode on the positive electrode side of the solid-state battery, and another electrode layer on the main surface of the substrate is consistent with the folded portion of the end-face electrode on the negative electrode side of the solid-state battery, and bonding and connection are performed using a conductive paste (for example, an Ag conductive paste). More particularly, a precursor 600′ of the bonding member that plays a part in electrical connection between the solid-state battery 100 and the substrate 200 may be provided in advance. Such a precursor 600′ of the bonding member can be provided by printing with a conductive paste that requires no cleaning such as flux after being formed, such as a nano-paste, an alloy-based paste, and a brazing material, in addition to an Ag conductive paste. Subsequently, the solid-state battery 100 is placed on the substrate such that the end-face electrodes of the solid-state battery and the precursor 600′ of the bonding member are brought into contact with each other, and a heating treatment is performed, thereby forming, from the precursor 600′, the bonding member 600 that contributes to electrical connection between the solid-state battery 100 and the substrate 200.

Subsequently, a covering material is formed. As shown in FIG. 9(E), a covering insulating layer 160 and a covering inorganic layer 170 may be provided as a covering material 150.

First, the covering insulating layer 160 is formed so as to cover the solid-state battery 100 on the substrate 200. Hence, a raw material for the covering insulating layer 160 is provided such that the solid-state battery on the substrate is totally covered. When the covering insulating layer is made of a resin material, a resin precursor is provided on the substrate and subjected to curing or the like to mold the covering insulating layer. According to a preferred aspect, the covering insulating layer may be molded by pressurization with a mold. By way of example only, a covering insulating layer for sealing the solid-state battery on the substrate may be molded through compression molding. In a case of a resin material generally for use in molding, the form of the raw material for the covering insulating layer may be granular, and the type thereof may be thermoplastic. It is to be noted that such molding is not limited to die molding, and may be performed through polishing processing, laser processing, and/or chemical treatment.

After the covering insulating layer 160 is formed, the covering inorganic layer 170 is formed. Specifically, the covering inorganic layer 170 is formed on the “covering precursor in which each solid-state battery 100 is covered with the covering insulating layer 160 on the support substrate 200”. For example, a plating layer is formed. Although it is merely an example, dry plating may be performed to provide a dry plating film as the covering inorganic layer.

Through the above steps, it is possible to obtain a packaged article in which the water vapor barrier layer is provided between the substrate and the solid-state battery, and the solid-state battery on the substrate is totally covered with the covering insulating layer and the covering inorganic layer. More particularly, the “solid-state battery package” according to the present invention can be finally obtained.

Although the aspects of the present invention have been described above, only typical examples have been illustrated. Those skilled in the art will easily understand that the present invention is not limited thereto, and various aspects are conceivable without changing the gist of the present invention.

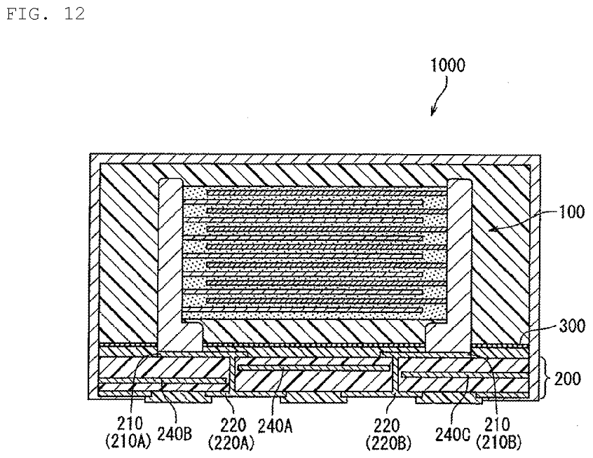

For example, in the above description, the drawings illustrating a form in which the solid-state battery package has a resist layer are used, but the present invention is not particularly limited thereto. For example, the resist layer may not be provided between the substrate 200 and the solid-state battery 100 (see FIG. 10). That is, for example, the resist layer 400 described with reference to FIG. 5 may not be provided. As shown in FIG. 10, since there is no resist layer between the substrate 200 and the solid-state battery 100, the water vapor barrier 300 may be disposed directly on a base material portion (for example, a resin portion or a ceramic portion) on the substrate and/or on the electrode layer 210 (the electrode layer 210A on the positive electrode side and/or the electrode layer 210B on the negative electrode side) on the substrate surface.

In the above description, the form in which the package has the covering material 150 has been mentioned, but the present invention may have a form in which the solid-state battery 100 is largely covered with the covering material 150. For example, the covering inorganic layer 170 provided on the covering insulating layer 160 that covers the solid-state battery 100 on the substrate 200 may extend to the lower main surface of the substrate 200 (see FIG. 2). That is, as the covering material 150, the covering inorganic layer 170 on the covering insulating layer 160 may extend to the side surface of the substrate 200, and beyond the side, extend to the lower main surface of the substrate 200 (particularly, the peripheral edge portion thereof). In the case of such a form, a solid-state battery package may be provided in which moisture transmission (moisture transmission from the outside to the solid-state battery stacked body) is more suitably prevented. As illustrated in FIG. 11, the covering inorganic layer 170 can also be provided as a multilayer structure composed of at least two layers. In FIG. 11, the covering inorganic layer 170 having a two-layer structure of 170A and 170B is illustrated. Such a multilayer structure is not particularly limited to between different types of materials, and may be between the same type of materials. When the covering inorganic layer having such a multilayer structure is provided, the characteristics of the water vapor barrier of the whole package can be improved. When the covering inorganic layer is provided, the water vapor barrier layer may extend to reach or contact the covering inorganic layer. In particular, the water vapor barrier layer 300 may extend to reach or contact the covering inorganic layer 170 that covers the side surface of the solid-state battery 100 (see FIGS. 2 and 11). As can be seen from the sectional view of FIG. 2 and FIG. 11, this is because water vapor infiltrating from the external environment via the substrate 200 can be more reliably prevented. In other words, when the covering inorganic layer 170 is provided on the covering insulating layer 160 so as to cover at least the covering insulating layer 160, the water vapor barrier layer 300 may extend up to the covering inorganic layer 170 (in particular its internal side surface or internal surface) that covers the side surface of the solid-state battery 100. In such an aspect, the water vapor barrier layer can more reliably act so that external water vapor infiltrating through the substrate does not reach the solid-state battery, and a solid-state battery package in which deterioration of solid-state battery characteristics is suppressed in a longer term is provided. When the covering inorganic layer 170 is provided on the covering insulating layer 160, it can be said that the water vapor barrier layer 300 extending to the outer side surface or the outer surface of the covering insulating layer 160 may be in contact with the covering inorganic layer 170.

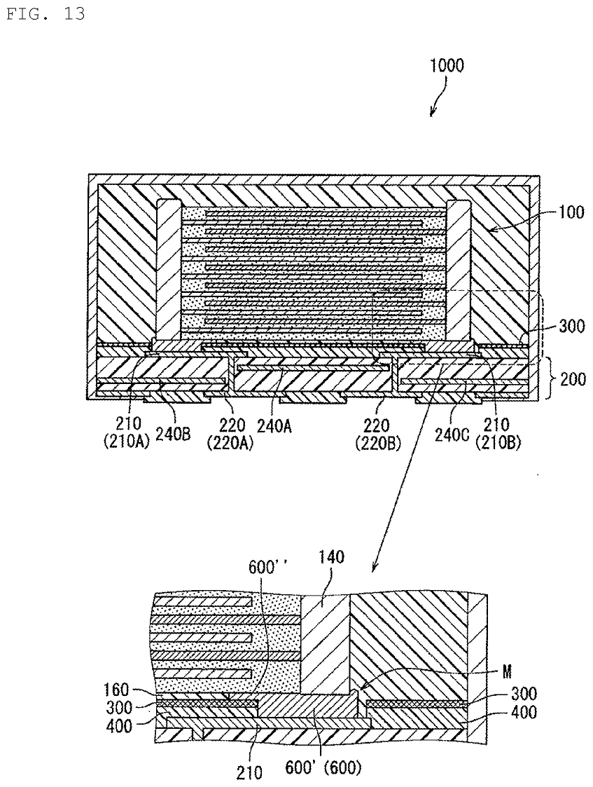

In the above description, a metal layer having a high “metal area ratio” is mentioned, but the present invention may achieve a high metal area ratio from a plurality of substrate metal layers. As shown in FIG. 12, a plurality of metal layers, for example, metal layers provided as a metal layer 240A, a metal layer 240B, and a metal layer 240C, may achieve a metal area ratio of 90% or more, preferably a metal area ratio of 95% or more, and more preferably a metal area ratio of 99% or more. This means that the total area of the planar shape of the plurality of metal layers such as the metal layer 240A, the metal layer 240B, and the metal layer 240C may have an area ratio (area ratio with respect to the area of the substrate 200 in plan view shape) of 90% or more, preferably 95% or more, and more preferably 99% or more. It can be said that the target metal layer may have a metal area ratio of more preferably 99% or more in total in plan view. Note that such a plurality of metal layers (for example, the metal layer 240A, the metal layer 240B, and the metal layer 240C) may be positioned on mutually different planes inside the substrate (briefly, at mutually different height levels or depth levels) and/or may not overlap each other in a plan perspective view of the substrate.

In the above description, the via in the opening region of the metal layer has been mentioned, and it can also be understood that the metal layer or the metal portion connecting the first electrode layer and the second electrode layer has a via structure. That is, a metal structure or a metal portion communicating in one layer or multiple layers in a sectional view may be provided in the substrate. In view of such matters, the substrate according to the present invention can be expressed in various metal layer forms. For example, in the substrate, a first metal layer may be positioned between the first electrode layer (electrode layer for electrical connection with the solid-state battery on one main surface of the substrate) and the second electrode layer (electrode layer for mounting the solid-state battery package on an external board on the other main surface of the substrate), and the substrate may further include a second metal layer that is not connected to the first electrode layer or the second electrode layer. The first metal layer may preferably correspond to a metal layer (or a metal portion, for example a via portion) that electrically connects the first electrode layer and the second electrode layer to each other. In such a case, between the first electrode layer and the second electrode layer, the substrate may have the first metal layer (or a metal portion, for example a via portion) electrically connected to the first electrode layer and the second electrode layer, and the second metal layer not electrically connected to the first electrode layer or the second electrode layer. The first metal layer and the second metal layer may be made of the same metal material, or may be made of different metal materials. In such an aspect, the water vapor transmission from the external environment to the solid-state battery can be suitably prevented in the solid-state battery package while the package substrate is provided as a terminal substrate for the external terminal of the solid-state battery. The first metal layer and the second metal layer may be positioned on the same plane (in short, at the same height level or depth level) in the inner part of the substrate, or may be positioned on different planes (in short, at different height levels or depth levels). In addition, the area of the first metal layer and the second metal layer in plan view shape may be, for example, 90% or more with respect to the area of the substrate in plan view shape. More specifically, the total area of the first metal layer in plan view shape and the second metal layer in plan view shape is preferably 90% or more, more preferably 95% or more, and still more preferably 99% or more with respect to the area of the substrate in plan view shape (the upper limit value of such an area ratio may be 100%). When such an area relationship is provided, water vapor transmission from the external environment to the solid-state battery can be more suitably prevented.

Furthermore, in the above description, an aspect in which the conductive portion of the substrate and the end-face electrode of the solid-state battery are electrically connected to each other using the conductive paste provided for the substrate has been mentioned, but the provided conductive paste 600′ may finally have a form as shown in FIG. 13. When the solid-state battery 100 and the substrate 200 are electrically connected via the conductive paste 600′, a pressing force is applied from the solid-state battery 100 to the conductive paste 600′, so that the end-face electrode 140 of the solid-state battery 100 tends to slightly bite into the conductive paste 600′. That is, the conductive paste 600′ is likely to have a form in which it is pressed by the end-face electrode 140 and slightly swells outside thereof (the “M” portion in FIG. 13). In addition, when the solid-state battery 100 and the substrate 200 are electrically connected via the conductive paste 600′, a part of the conductive paste 600′ may flow so as to straddle the resist layer 400 due to pressing the conductive paste 600′. That is, as illustrated in FIG. 13, while the conductive paste 600′ is positioned on the main surface electrode layer 210 of the substrate on the inner side of the resist layer 400 and the water vapor barrier layer 300, a part 600″ thereof extends onto the water vapor barrier layer 300. This is related to the fact that the resist layer 400 and the water vapor barrier layer 300 act as a “dam” for the conductive paste 600′. More specifically, in the opening portions of the resist layer 400 and the water vapor barrier layer 300 where the conductive portion (in particular, the main surface electrode layer 210 of the substrate) of the substrate is exposed, the edge portion forming the opening acts so as to partly prevent the conductive paste 600′ moving. Therefore, while a part of the conductive paste 600′ once provided into the opening portion flows onto the water vapor barrier layer 300 along with the pressing, most of the conductive paste 600′ can remain in the opening portion of the resist layer 400 and the water vapor barrier layer 300. That is, preferably, the resist layer (for example, a solder resist layer) and the water vapor barrier layer thereon act as a dam to suppress the bleeding of the conductive paste. When the bleeding of the conductive paste is suppressed, the bonding area between the water vapor barrier layer 300 and the covering insulating layer 160 (particularly, the covering insulating layer 160 provided between the solid-state battery 100 and the substrate 200) is easily secured, and the fixing force between them can be more stabilized. Although the conductive paste 600′ is expressed on the premise of manufacturing, the conductive paste 600′ corresponds to the bonding member 600 in the manufactured solid-state battery. Therefore, in the solid-state battery package 1000 according to an aspect of the present disclosure, as shown in FIG. 13, the bonding member 600 is positioned on the inner side of the resist layer 400 and the water vapor barrier layer 300 (particularly, in a region on the upper main surface electrode layer 210 of the substrate), and a part thereof extends onto the water vapor barrier layer 300.

Although the present invention relates to a solid-state battery package, the package may be provided as an electronic device mounted on an external board separate from the substrate. That is, while the substrate of the solid-state battery package can be a terminal substrate for the external terminal of the solid-state battery, the solid-state battery package may be surface-mounted on an external board (that is, the secondary substrate) such as a printed wiring board via the terminal substrate, and the solid-state battery package may be provided as such an electronic device.

The solid-state battery package according to the present invention can be used in various fields where battery use or power storage can be assumed. By way of example only, the solid-state battery package according to the present invention can be used in the fields of electricity, information, and communication in which mobile devices and the like are used (such as the field of electric/electronic devices and the field of mobile devices including small electronic devices such as mobile phones, smartphones, notebook computers and digital cameras, activity trackers, arm computers, electronic paper, RFID tags, card-type electronic money, and smartwatches), home and small industrial applications (such as the fields of power tools, golf carts, and home, nursing, and industrial robots), large industrial applications (such as the fields of forklifts, elevators, and harbor cranes), the field of transportation systems (such as the fields of hybrid vehicles, electric vehicles, buses, trains, power-assisted bicycles, and electric two-wheeled vehicles), power system applications (such as the fields of various types of power generation, road conditioners, smart grids, and home energy storage systems), medical applications (field of medical equipment such as earphone hearing aids), pharmaceutical applications (fields such as dosage management systems), IoT fields, space and deep sea applications (such as the fields of space probes and submersibles), and the like.

### DESCRIPTION OF REFERENCE SYMBOLS

100: Solid-state battery
100A: Top surface (upper surface) of solid-state battery
100B: Side surface of solid-state battery
110: Positive electrode layer
120: Negative electrode layer
130: Solid electrolyte or solid electrolyte layer
140: End-face electrode
140A: End-face electrode on positive electrode side
140B: End-face electrode on negative electrode side
150: Covering material
160: Covering insulating layer
160A: Outer surface of covering insulating layer
170: Covering inorganic layer
170A: Sub covering inorganic layer (sub lower layer)
170B: Sub covering inorganic layer (sub upper layer)
200: Substrate
200′: Layer forming stacked structure of substrate
210: Main surface electrode layer (substrate upper side)
210A: Upper main surface electrode layer on positive electrode side
210B: Upper main surface electrode layer on negative electrode side
220: Main surface electrode layer (substrate lower side)
220A: Lower main surface electrode layer on positive electrode side
220B: Lower main surface electrode layer on negative electrode side
240: Metal layer of substrate
245: Opening of metal layer
300: Water vapor barrier layer
310: Water vapor barrier layer portion partly located on substrate
400: Resist layer
500: Bonding region between end-face electrode of solid-state battery and electrode layer of substrate
600: Bonding member
600′: Bonding member precursor
1000: Solid-state battery package
M: Swelling of conductive paste/bonding member

1. A solid-state battery package comprising:
a substrate;
a solid-state battery on the substrate; and
a water vapor barrier layer between the substrate and the solid-state battery.

2. The solid-state battery package according to claim 1, wherein the water vapor barrier layer is thinner than a layer constituting a stacked structure of the solid-state battery.

3. The solid-state battery package according to claim 1, wherein the water vapor barrier layer is an insulating film.

4. The solid-state battery package according to claim 1, wherein the water vapor barrier layer has both an Si—O bond and an Si—N bond.

5. The solid-state battery package according to claim 4, wherein the water vapor barrier layer has a thickness of 10 nm to 900 nm.

6. The solid-state battery package according to claim 4, wherein the water vapor barrier layer has: a first in-layer region proximal to the solid-state battery; and a second in-layer region proximal to the substrate, wherein, the first in-layer region contains a larger amount of the Si—O bond than the second in-layer region, and the second in-layer region contains a larger amount of the Si—N bond than the first in-layer region.

7. The solid-state battery package according to claim 1, wherein the water vapor barrier layer has a water vapor transmission rate of less than 5×10⁻³ g/(m²·Day).

8. The solid-state battery package according to claim 1, further comprising:
a resist layer on the substrate,
wherein the water vapor barrier layer has a water vapor transmission rate lower than that of the resist layer.

9. The solid-state battery package according to claim 1, wherein the water vapor barrier layer extends along a surface direction of the substrate.

10. The solid-state battery package according to claim 9, further comprising a covering insulating layer covering a main surface and a side surface of the solid-state battery,
wherein the water vapor barrier layer extends to an outer surface of the covering insulating layer which covers the side surface.

11. The solid-state battery package according to claim 9, further comprising:
a covering insulating layer covering a main surface and a side surface of the solid-state battery; and
a covering inorganic layer on the covering insulating layer,
wherein the water vapor barrier layer extends to an inner side surface of the covering inorganic layer which covers the side surface of the solid-state battery.

12. The solid-state battery package according to claim 1, wherein
the substrate includes a metal layer, and
an outer contour of the substrate in a plan view overlaps an outer contour of the metal layer in the plan view.

13. The solid-state battery package according to claim 12, wherein the substrate has: a first electrode layer electrically connected to the solid-state battery; and a second electrode layer that mounts the solid-state battery package to an external board, and the metal layer is between the first electrode layer and the second electrode layer.

14. The solid-state battery package according to claim 12, wherein an area of the metal layer in the plan view is 99% or more with respect to an area of the substrate in the plan view.

15. The solid-state battery package according to claim 12, wherein the metal layer extends to a side surface of the substrate.

16. The solid-state battery package according to claim 12, wherein the metal layer defines an opening region that is circular in the plan view.

17. The solid-state battery package according to claim 1, wherein
the substrate has: a first electrode layer electrically connected to the solid-state battery; and a second electrode layer that mounts the solid-state battery package to an external board, and
the solid-state battery package has, between the first electrode layer and the second electrode layer, a first metal layer that is electrically connected with the first electrode layer and the second electrode layer, and a second metal layer that is not electrically connected with the first electrode layer and the second electrode layer.

18. The solid-state battery package according to claim 17, wherein the first metal layer and the second metal layer have a total area that is 99% or more with respect to an area of the substrate in a plan view.

19. The solid-state battery package according to claim 1, wherein the substrate is a resin substrate.

20. The solid-state battery package according to claim 1, wherein the water vapor barrier layer contains silicon.
